(19) United States
(12) Patent Application Publication
(10) Pub. No.: US 2026/0166655 A1
(43) Pub. Date: Jun. 18, 2026

(54) APPARATUS AND METHOD FOR MARKING OBJECTS BY LASERS

(71) Applicant: KRONES AG, Neutraubling (DE)

(72) Inventors: Johannes BAUER, Ergoldsbach (DE); Ralf URBAN, Teugn (DE)

(21) Appl. No.: 19/418,222

(22) Filed: Dec. 12, 2025

(30) Foreign Application Priority Data
Dec. 12, 2024 (DE) 102024137326.1

(51) Int. Cl. B23K 26/362; B23K 26/70

(52) U.S. Cl. CPC B23K 26/362; B23K 26/707

(57) ABSTRACT

An apparatus for marking objects, and in particular containers, container closures, or labels, includes a transport device, which transports the objects along a predefined transport path, and a marking device, which is configured for providing the objects with a marking, wherein the marking device including a laser generation unit for generating a laser bundle and an exit element via which the laser bundle exits the marking device, wherein the apparatus includes an inspection device which is configured for inspecting the exit element.

### CROSS REFERENCE TO RELATED APPLICATION

The present application claims benefit to German Patent Application Serial No. 10 2024 137 326.1, filed Dec. 12, 2024, the contents of which are incorporated herein by reference.

### BACKGROUND OF THE INVENTION

The present invention relates to an apparatus and to a method for marking objects, and in particular containers. Highly diverse approaches for marking containers are known from the prior art. It is known to provide containers with labels or printing.

However, many of these approaches have the disadvantage of involving increased effort in the disposal or recycling of the containers.

More recently, apparatuses and methods have become known in which lasers are used to mark the objects, and in particular containers. It is known that lasers can engrave markings into the wall of containers.

These lasers often have complex and expensive optical systems, such as movable mirrors, which effect the movement of the exiting laser bundle. These optical systems are usually arranged in a housing so as to be well protected from environmental influences.

DE 10 2011 056 436 A1 discloses an apparatus for treating beverage containers which comprises a marking device for marking the containers.

DE 10 2020 123 479 A1 describes a method for monitoring the state of a laser-machining head.

DE 10 2017 101 223 A1 discloses a machine learning apparatus for learning conditions for starting laser apparatuses.

DE 101 13 518 A1 describes a method for measuring the degree of contamination of a protective glass of a laser-machining head.

DE 10 2007 003 023 B4 discloses an optoelectronic sensor and a method for testing the light permeability of a protective pane.

Further, in such marking devices, however, an exit element, such as an exit lens, through which the laser bundle (often also referred to as a laser beam) exits, is also provided.

At least the outer side of this exit element is more exposed to environmental influences. Generally, laser-marking devices have lenses attached at the exit point of the laser bundle, similar to cameras. These allow the beam or laser bundle to impinge in a directed manner onto the object and/or substrate to be marked. These lenses are part of a complex optical system that comprises several mirror deflections. Some of these mirrors are driven by motors, such as galvo motors, or other drive elements.

These exit elements or lenses must be very clean and undamaged in order to allow high-precision laser marking. Contaminated or damaged exit elements, and in particular lenses, in laser-marking devices can lead to markings that no longer meet the quality standards. This in turn can lead to complaints from customers, or even to the readability of the particular marking being no longer ensured. If the marking is examined, this examination can also lead to the object in question being treated as a reject and removed.

The marking applied to the objects, and in particular containers, by the marking device is particularly preferably a machine-readable marking or human-readable characters in any language. The objects to be marked are particularly preferably made of plastic material, and in particular containers made of plastic material, and in particular plastic material bottles, made of, for example, polyethylene terephthalate.

The object of the present invention is therefore improving the reliability of the marking process and also the quality of the marking.

### SUMMARY OF THE INVENTION

An apparatus according to the invention for marking objects, and in particular containers, and in particular plastic material containers, comprises a transport device, which transports the objects along a predefined transport path, and a marking device, which is suitable and intended for providing the objects with a marking, wherein the marking device comprises a laser generation unit for generating a laser bundle and an exit element via which the laser bundle exits the marking device.

According to the invention, the apparatus comprises an inspection device which is suitable and intended for inspecting the exit element.

Therefore, within the scope of the invention, it is proposed to inspect and in particular monitor the element which is in particular susceptible to contamination. Preferably at least one surface of the exit element is inspected. Preferably a surface of the exit element is inspected which comes into contact with an environment of the marking device. However, it would also be conceivable to inspect an inner region of the exit element, for example a lens body. For example, it can have damage, such as air inclusions or cracks, and therefore distort the laser marking.

The objects are particularly preferably containers, and in particular blow-molded containers, and in particular stretch blow-molded containers. The containers are particularly preferably made of plastic material, and in particular of PET.

The containers particularly preferably have a predefined recycled content, and in particular a recycled content greater than 60%, and preferably greater than 80%, or up to a maximum of 100%. However, the containers can also be made from new virgin plastic material.

In a further preferred embodiment, the transport device is suitable and intended for transporting the containers and/or plastic material preforms separately. The transport device preferably transports the plastic material containers along a circular path. The transport device can thus have a rotatable carrier or plate on which a container is arranged. The containers are clamped between the plate and a centering apparatus on the upper side. The plates are preferably rotated by electronic motors, in particular servo motors.

In a further preferred embodiment, the apparatus comprises several marking devices for marking the plastic material containers. These marking devices are preferably marking devices which include a laser generation device.

These marking devices are preferably at least partially, and preferably all, synchronized with each other. These marking devices are preferably arranged one after the other along the transport path of the containers.

In a further advantageous embodiment, the transport device is a

transport belt—in particular a one-way transport belt—for example, if the objects have planar surfaces, such as container closures or shaped bottles having triangular, rectangular or oval cross-sections.

Further, the transport device can also have a linear motor guide.

The marking device is preferably stationary and preferably marks the containers transported past this marking device.

The transport device is preferably suitable and intended for transporting the containers at a velocity between 10,000 and 150,000 c/h, preferably between 20,000 and 140,000 c/h, and particularly preferably between 30,000 and 130,000 c/h.

In a further advantageous embodiment, the apparatus comprises a checking device or further inspection device which is suitable and intended for inspecting the marking arranged on the containers. This checking device is preferably arranged downstream of the marking device along the transport path of the containers. This checking device preferably comprises an image recording device which records at least one image of each object, and in particular container, provided with a marking.

The marking device is preferably suitable and intended for placing the marking on a main body or on a neck region of the container. The laser device preferably has an intensity and/or power that makes it possible to engrave the marking into a plastic material of the container.

However, the objects to be marked can also be containers made of pulp or paper. Further, the objects can be closures, and in particular container closures, and in particular container closures made of plastic material.

Further, the objects can be cans, in particular made of a metal, such as aluminum or steel.

Further, the objects can be labels, and in particular labels attached to containers. These labels can consist of paper or plastic material, or comprise these materials.

In a further advantageous embodiment, the laser marking device and/or the laser has a power greater than 1 W, preferably greater than 2 W, preferably greater than 5 W, preferably greater than 10 W, preferably greater than 20 W, and preferably greater than 40 W.

In a further advantageous embodiment, the laser marking device and/or the laser has a power of less than 500 W, preferably less than 400 W, preferably less than 300 W, preferably less than 250 W, preferably less than 200 W, and particularly preferably less than 150 W.

In a further advantageous embodiment, the apparatus comprises an ejection device that is suitable and intended for ejecting individual objects, and in particular containers, in response to a result from the checking device.

In a further preferred embodiment, the marking device comprises a movement device which is suitable and intended for moving the exiting laser bundle (or the exiting laser beam) in a plane that is perpendicular to the optical beam direction of the laser bundle. In this way, even more complex markings can be arranged on the container.

In a further preferred embodiment, the apparatus comprises a rotating

device which rotates the object, and in particular the container or a container closure—in particular during the marking process—about its longitudinal axis.

In a further preferred embodiment, the apparatus comprises a cooling device for cooling the marked region of the object, and in particular the container.

In a further preferred embodiment, the marking device comprises a deflection device for deflecting the laser bundle. This deflection device can preferably comprise an arrangement, arranged inside the marking device or laser device, consisting of one or several mirrors, wherein preferably a position and/or location of at least one of these mirror elements can be changed.

For this purpose, drives can be provided inside a housing; for example, galvo motors can be provided. The marking device preferably comprises a galvo laser or a galvo laser system.

The galvo laser system preferably comprises one or more small motors which drive the mirrors of the laser system. These mirrors play a central role in aligning the laser beam.

Preferably, two or more mirrors, and in particular preferably precisely two mirrors, are used. Each mirror is preferably controlled by its own galvanometer scanner. One mirror preferably adjusts the X-axis movement of the laser beam; the other adjusts the Y-axis movement.

The motors which are preferably used ensure fast and precise adjustment of the mirrors, which is advantageous for rapid repositioning of the laser beam over the object to be marked.

Other elements optical elements can also be provided in the marking device, such as optical gratings, mirrors, prisms, apertures, lenses, and the like.

In a further preferred embodiment, the inspection device is suitable and intended for detecting an anomaly in the exit element. An anomaly is understood in particular to be a deviation from a target state of the exit element, wherein the following examples are given.

The anomaly is particularly preferably selected from a group of anomalies which includes contamination of the exit element, damage to and defects of the exit element, damage or contamination on the surface of the exit element, or also damage inside the exit element. Further, the anomaly or damage could be a misalignment of the exit element, such as an unintentional tilt of a lens.

The contamination can include, for example, dirt, dust, particles, abrasion or shards, but also water droplets or condensate on a surface of the exit element. The damage can include, for example, scratches, cracks, or other defects.

In a further preferred embodiment, the inspection device is suitable and intended for contactlessly detecting the anomaly in the exit element. For example, a surface of the exit element can be monitored with a camera, or contactless temperature sensors or optoelectronic elements can be provided which detect the temperature of the exit element, for example even a local elevated temperature. For example, contamination can lead to a locally elevated temperature.

In a preferred embodiment, the inspection device comprises an illuminating device which illuminates a surface of the exit element, and in particular illuminates for carrying out the inspection. This illumination device can, for example, illuminate the surface with visible light, IR, or even UV light to make certain defects visible.

In a further preferred embodiment, the marking device allows an inspection mode which is intended for inspecting the exit element. For example, in such an inspection mode, the exit surface of the exit element can be scanned by the laser, and any defects can be detected in the process.

In a further preferred embodiment, the inspection device is suitable and intended for outputting at least one signal that is characteristic of the anomaly of the exit element and/or the occurrence of an anomaly. For example, an error message can be output, or a message which indicates that the exit element should be cleaned.

In a further preferred embodiment, the inspection device comprises an image recording device which is suitable and intended for recording at least one image of at least one section of the exit element.

As discussed in more detail below, this image can be used, for example, to draw conclusions about the nature of the anomaly.

In a further preferred embodiment, the apparatus comprises an evaluation device which is suitable and intended for evaluating measurement data and/or images recorded by the inspection device which are characteristic of the exit element and/or the anomaly, and to output at least one value which is characteristic of a result of this evaluation.

For example, information can be provided about what type of anomaly is present, such as contamination, a water droplet, or damage. In addition, it can also be specified in which region of the exit element this anomaly is present.

In addition, instructions for eliminating the anomaly can also be provided.

In a further advantageous embodiment, the evaluation device is suitable and intended for carrying out the evaluation using artificial intelligence (AI).

More precisely, the evaluation is based on an image evaluation model based on machine learning.

The machine learning image evaluation model is preferably based on an (artificial) neural network. The neural network is preferably formed as a deep neural network (DNN), in which the parameterizable processing chain comprises a plurality of processing layers, and/or a so-called convolutional neural network (CNN) and/or a recurrent neural network (RNN).

The data (to be processed), in particular the spatially resolved images (or data derived therefrom), are preferably supplied as input variables to the image evaluation model or the (artificial) neural network. The image evaluation model or the artificial neural network preferably maps the input variables onto output variables on the basis of a parameterizable processing chain, wherein the type of anomalies of the exit element, the type of contamination, the location and/or type of damage to or in the exit element, the extent of damage and/or contamination are preferably chosen as the output variable.

The image evaluation model based on machine learning is/was preferably trained using predefined training data, wherein a or the parameterizable processing chain is preferably parameterized by the training.

In a preferred method, training data which comprise a plurality of spatially resolved images recorded by the at least one image recording device (or another image detecting device) (in particular from different exit elements) are used in the training process of the image-evaluation-model. This offers the advantage that the training process is already specifically matched to the inspection apparatus used or to be used, and thus, for example, specific circumstances of the specific inspection apparatus, such as optical properties of the image recording device, or even specific light conditions in the inspection apparatus, can be directly taken into account.

The spatially resolved images (recorded by the at least one image recording device) provided for use as training data are preferably provided with anomaly-type and/or classification features.

The spatially resolved images, together with their respective assigned anomaly types and/or defect types (e.g., scratches, fractures, air inclusions, etc.) and/or contamination types (type of contamination, for example, dust, water droplets, or other contamination) and/or classification features, are preferably stored and/or used as a training data set (in particular on a volatile and/or non-volatile memory device). A plurality of training data sets is preferably generated in this way.

The classification features can preferably be the extent of a contamination (a geometric extent), a geometric shape of contamination, a color of contamination, a transparency of contamination, a refractive index of contamination, a size of a defect, a position of a defect (e.g., on the surface or inside the exit element), a refractive index of a defect, a type of defect (e.g., scratch or fracture), and the like.

By using an image evaluation model based on machine learning, it is achieved that a (complex) combination of different features and/or reference regions (in the training process) that is optimal for data processing, and features (or combinations of features) adapted to diverse different contamination types and/or defect types, or generally to anomaly types, are identified or determined.

This offers the advantage whereby, when evaluating the at least one spatially resolved image using the trained image evaluation model, the type of anomaly, the position of an anomaly, the type of contamination, and/or the type of defect can be determined with high precision.

For example, recorded images can be evaluated using this artificial intelligence.

In a further preferred embodiment, the laser generation unit is selected from a group of laser generation units which includes CO2 lasers, Nd:Yag lasers, fiber lasers, UV lasers, green lasers, or ultrapulse lasers, or a combination thereof.

The laser generation unit preferably emits laser light in the visible wavelength range, but other wavelength ranges would also be conceivable, such as, in particular but not exclusively, wavelengths in the ultraviolet range, or wavelengths in the near-infrared range. The laser is preferably a continuous wave (cw) laser, but a pulsed laser would also be conceivable, such as a laser that emits pulses in the nano-, pico-, or femtosecond range.

In a further preferred embodiment, the exit element is selected from a group of exit elements which includes lenses, exit windows, mirrors, and prisms.

In a further preferred embodiment, the apparatus comprises a measure-triggering device which, in response to the detection of an anomaly in the exit element, triggers a measure and, in particular, a measure which eliminates this anomaly or represents a counter-reaction to this anomaly.

This measure is preferably selected from a group of measures that includes prompting a user to clean the exit element, automated cleaning of the exit element, prompting a user to change the exit element, automated changing of the exit element, issuing a warning to the user, instructing the user to change at least one parameter of the marking unit, changing at least one parameter of the marking unit, and the like.

For example, a cleaning process can be triggered automatically. It is also possible for the cleaning process to be triggered depending on the type of contamination. If it is detected, for example, that the anomaly is caused by contamination in the form of, e.g., dust, the triggered cleaning process can be a blow-off process in which a surface of the exit element is blown with air.

If the anomaly is caused by a foreign body adhering to the exit element, the countermeasure can involve cleaning the exit element with a cleaning fluid.

If more stubborn contamination is detected, cleaning with a cleaning element, such as a brush element, can be initiated.

If damage is detected, the user can be prompted, for example, to replace the exit element. As mentioned, the exit element can also be replaced automatically.

However, it would also be conceivable to adapt the laser unit itself. For example, the exit point of the laser bundle in the exit element could be changed, for example to bypass the location of a defect.

In addition, the laser's power could be changed, the exit region could possibly be slightly modified, or the exit element could be shifted.

In a further preferred embodiment, the apparatus comprises a cleaning device for automatically cleaning the exit element. For example, in response to a detected anomaly, a cleaning device can clean the surface of the exit element, wherein this cleaning process can also be adapted to the type of anomaly.

In a further preferred embodiment, the apparatus comprises a changing device for automatically changing the exit element. This changing device preferably performs a change of the exit element in response to certain anomalies, such as damage to the exit element.

In a further advantageous embodiment, the marking device comprises a housing in which the laser generation unit is arranged and on which the exit element is arranged. The laser generation unit typically comprises very sensitive optical components. These are preferably completely enclosed by the housing.

Preferably, the marking device comprises a bundle directing device which directs the generated laser bundle and/or can move the exit position in a plane which is perpendicular to the optical path of the laser bundle, in particular to generate the marking in this way.

As mentioned, this bundle directing device can have one or several mirrors, which are preferably movable by a drive device. Preferably, this bundle directing device is also arranged inside the aforementioned housing.

In a further preferred embodiment, the inspection device comprises at least one sensor device, which is arranged in this housing and is particularly preferably suitable and intended for detecting at least one parameter which is characteristic of the exit element.

Preferably, the beam bundle is analyzed on the exit element based on the resulting (residual) reflection.

In a further preferred embodiment, the inspection device comprises at least one image recording device arranged outside the housing. This inspection device preferably inspects the exit element. The inspection device preferably comprises an illumination device for illuminating the exit element. For example, ring lighting can be provided which illuminates the exit element.

The illumination and checking of the exit element takes place particularly preferably between the inscription processes.

In a further preferred embodiment, the apparatus comprises a control loop for eliminating anomalies of the exit element. This allows the inspection device to detect an anomaly and accordingly output a signal to a cleaning device for cleaning the exit element. After the cleaning process has been completed, the inspection device can inspect the exit element again and, if necessary, initiate a further cleaning process.

The present invention is further directed to a marking device for marking objects, and in particular containers, container closures, or labels, comprising a housing and a laser generation unit arranged within the housing, as well as an exit element via which a laser bundle generated by the laser generation unit exits the marking device.

According to the invention, an inspection device is provided which is suitable and intended for inspecting the exit element.

The exit element preferably forms the only region of the marking device via which laser radiation or laser light can exit the marking device, and in particular a housing of the marking device.

The present invention is further directed to a method for marking objects, and in particular containers, wherein a transport device transports the objects along a predefined transport path and a marking device provides the objects with a marking (and in particular with an optically perceptible marking), wherein the marking device comprises a laser generation unit, which generates a laser bundle, and an exit element, via which the laser bundle exits the marking device.

According to the invention, the apparatus comprises an inspection device which inspects the exit element at least at times. It is therefore also proposed, on the method side, that the exit element be inspected and, if necessary, anomalies of this exit element be detected.

The inspection device preferably detects at least one anomaly of the exit element. The inspection device particularly preferably outputs at least one signal and/or measurement value that is characteristic of this anomaly.

### BRIEF DESCRIPTION OF THE DRAWINGS

Further advantages and embodiments emerge from the accompanying drawings.

In the drawings:

FIG. 1 shows a schematic representation of an apparatus according to the invention.

### DETAILED DESCRIPTION OF THE INVENTION

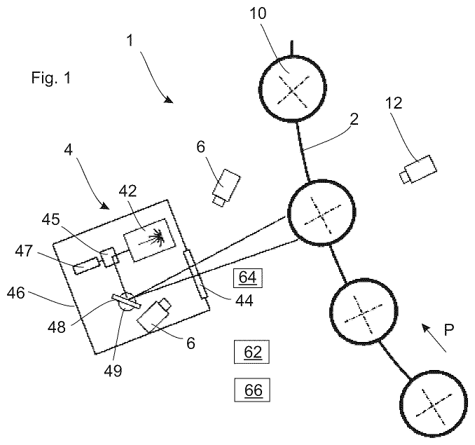

FIG. 1 shows a schematic representation of an apparatus 1 according to the invention for marking objects, in this case more precisely for marking containers 10.

This apparatus comprises a transport device 2 (represented only schematically), in this case such as a carrier wheel, which transports a plurality of containers 10 along a transport path P which is circular in this case. However, the transport device could also be a transport device that transports container closures.

It is possible that the containers 10 themselves are rotatable with respect to their longitudinal direction, which in this case runs perpendicularly to the plane of the FIGURE, and/or are rotated about their longitudinal direction by elements of the transport device.

Reference sign 4 denotes a marking device, more precisely a laser marking device, and in particular a laser engraving device, which provides each of the containers 10 with a marking. It is possible for the same marking to be applied to all containers 10, but it would also be possible for different markings to be applied to each of the containers.

This marking device 4 comprises a laser generation unit 42 which generates a laser beam or, more precisely, a laser bundle. Reference signs 45 and 48 denote deflecting mirrors which direct the generated laser bundle toward an exit element 44. The laser bundle exits through the exit element 44 and reaches the containers 10 in order to mark them.

Reference sign 45 denotes a first deflecting element, such as a deflecting mirror, for deflecting the laser bundle. Reference sign 47 denotes a drive device, such as a drive motor, which is intended to move the deflecting element 45.

Reference sign 48 denotes a second deflecting element, such as a deflecting mirror, for deflecting the laser bundle. Reference sign 49 denotes a second drive device, such as a drive motor, which is used to move the deflecting element 48.

Reference sign 6 denotes an inspection device for inspecting the exit element 44. As shown in FIG. 1, it is possible to provide, alternatively or cumulatively, an inspection device inside the housing 46 of the marking device, or to provide an inspection device 6 outside the housing.

The housing 46 is further intended for the purpose of protecting the optical elements inside the housing from environmental influences.

Reference sign 62 schematically denotes an evaluation device which is suitable and intended for evaluating the data, and in particular images, recorded by the inspection device(s) in order to thus conclude whether there is contamination of or damage to the exit element 44.

Reference sign 64 schematically denotes a cleaning device which is intended to clean the exit element or an outer surface of the exit element 44.

Reference sign 66 schematically denotes a measure-triggering device. This triggers, in response to a signal or value output by the evaluation device 62, a measure for remedying a detected anomaly of the exit element 44. For example, a cleaning process can be triggered or instructed. A machine operator can also be instructed to replace the exit element.

Reference sign 12 denotes a further inspection device, which is intended to examine the markings applied to the containers by the marking device 4.

In addition, a discharge device for discharging containers which have markings identified as faulty is preferably provided.

It is pointed out that all features which have been described with reference to the method are also correspondingly disclosed for the apparatus, which means in particular that the corresponding apparatus comprises devices which are suitable and intended for carrying out the particular methods. Further, features which were described with reference to the apparatus are also correspondingly applicable to the method or methods. This means that the methods are carried out using the corresponding apparatus features.

The applicant reserves the right to claim all features disclosed in the application documents as essential to the invention, provided that they are novel over the prior art individually or in combination. It is further pointed out that features which can be advantageous in themselves are also described in the individual figures. A person skilled in the art will immediately recognize that a particular feature described in a FIGURE can be advantageous even without the incorporation of further features from this FIGURE. Furthermore, a person skilled in the art will recognize that advantages can also result from a combination of several features shown in individual or in different figures.

1. An apparatus for marking objects, comprising a transport device configured to transport the objects along a predefined transport path, and comprising a marking device which is configured for providing the objects with a marking, wherein the marking device comprises a laser generation unit for generating a laser bundle and an exit element via which the laser bundle exits the marking device,
wherein
the apparatus comprises an inspection device which is configured for inspecting the at least one exit element.

2. The apparatus according to claim 1,
wherein
the inspection device is configured for detecting an anomaly of the exit element.

3. The apparatus according claim 1,
wherein
the anomaly is selected from a group of anomalies consisting of contamination of the exit element, damage to the exit element, and defects of the exit element.

4. The apparatus according to claim 2,
wherein
the inspection device is configured for contactlessly detecting the anomaly of the exit element.

5. The apparatus according to claim 2,
wherein
the inspection device is configured for outputting at least one signal that is characteristic of the anomaly of the exit element.

6. The apparatus according to claim 2,
wherein
the inspection device comprises at least one image recording device which is configured for taking at least one image of at least one section of the exit element.

7. The apparatus according to claim 2,
wherein
the apparatus comprises an evaluation device which is configured for evaluating measurement data and/or images recorded by the inspection device which are characteristic of the exit element and to output at least one value which is characteristic of a result of this evaluation.

8. The apparatus according to claim 7,
wherein
the evaluation device is configured for carrying out the evaluation using artificial intelligence.

9. The apparatus according to claim 1,
wherein
the laser generation unit is selected from a group of laser generation units consisting of CO2 lasers, Nd:Yag lasers, fiber lasers, UV lasers, green lasers, ultrapulse lasers, and a combination thereof.

10. The apparatus according to claim 1,
wherein
the exit element is selected from a group of exit elements consisting of lenses, exit windows, mirrors, and prisms.

11. The apparatus according to claim 2,
wherein
the apparatus comprises a measure-triggering device which is configured to trigger a measure in response to the detection of an anomaly in the exit element.

12. The apparatus according to claim 1,
wherein
the apparatus comprises a cleaning device configured for automatically cleaning the exit element and/or a changing device configured for automatically changing the exit element.

13. The apparatus according to claim 1,
wherein
the marking device comprises a housing in which the laser generation unit is arranged and on which the exit element is arranged.

14. A marking device for marking objects, comprising a housing and a laser generation unit arranged within the housing, as well as an exit element via which a laser bundle generated by the laser generation unit exits the marking device,
wherein
an inspection device is provided which is configured for inspecting the exit element.

15. A method for marking objects, wherein a transport device transports the objects along a predefined transport path and a marking device provides the objects with a marking, wherein the marking device comprises a laser generation unit, which generates a laser bundle, and an exit element, via which the laser bundle exits the marking device,
wherein
the apparatus comprises an inspection device which inspects the exit element at least at times.
